(19) United States
(12) Patent Application Publication
(10) Pub. No.: US 2026/0152341 A1
(43) Pub. Date: Jun. 4, 2026

(54) Disposable Debris Collector and Method

(71) Applicant: Kurt Vilhelmsen, Buckley, WA (US)

(72) Inventor: Kurt Vilhelmsen, Buckley, WA (US)

(21) Appl. No.: 18/966,892

(22) Filed: Dec. 3, 2024

(51) Int. Cl. B65F 1/00

(52) U.S. Cl. CPC B65F 1/0013

(57) ABSTRACT

A disposable debris collector designed to catch dust and debris from drilling or cutting holes in vertical surfaces. The collector is made from a rectangular or square sheet of paper with a back surface, front surface, top edge, bottom edge, and two vertical edges. The sheet's two lower corners are folded upward and over the front surface and meet at the sheet's midline axis. The bottom edge is folded and forms two half-edge sections vertically aligned over the sheet's midline axis. A lower adhesive is used to hold the two half-edge sections together and form a front seam. Because the sheet's side edges and adjacent surfaces resist bending, an expanding catch basin is formed. The top edge is attached to the vertical surface using an upper adhesive. In one embodiment, the upper and lower adhesives are peel-and-stick adhesives applied to the back and side surfaces, respectively.

### FIELD OF THE INVENTION

This invention pertains to debris collectors used to automatically collect falling debris created when drilling holes on a wall or vertical surface, and more particularly to such debris collectors made of paper.

### BACKGROUND OF THE INVENTION

Hospitals and medical clinics must implement and follow infection control standards designed to prevent and manage the spread of infections. These standards include eliminating activities around patients that generate dust particles, which could affect their breathing. Patient and examination rooms in hospitals and clinics, often called “cleanrooms,” are spaces where strict dust particle prevention measures are enforced.

In contrast, non-cleanroom environments, such as homes or office buildings, typically tolerate tiny amounts of dust particles produced during activities like drilling or cutting drywall. For larger tasks that generate significant dust particles, workers often use drop cloths to protect nearby furniture and floors. However, for smaller tasks, such as hanging pictures or mounting TVs on walls, workers forgo drop clothes, allowing a small amount of dust particles to settle, which can later be cleaned with a vacuum, broom, or mop.

When a drop blanket is unavailable, workers sometimes create a makeshift dust collector using a sheet of paper. As shown in FIGS. 1 and 2, the top edge of the paper is attached horizontally to the wall just below the drilling or cutting site. The bottom edge is folded two or three times to form a narrow horizontal lip. Push pins or painter's tape are used to secure the paper to the wall temporarily.

Paper dust collectors with narrow lower lips are not allowed in cleanroom environments because the lips do not extend far enough from the wall to effectively catch the dust particles. Additionally, when the paper dust collector is removed from the wall, the lip collapses causing dust particles captured by the lip to spill.

There is a need for a disposable debris collector made from a sheet of paper that can be used in both cleanroom and non-cleanroom environments and can be easily folded by the user to form a deep, outward-extending catch basin that retain its shape, enabling the collector to be removed from the wall without spilling.

### SUMMARY OF THE INVENTION

A debris collector made of a single sheet of paper that temporarily attaches to a wall or vertical surface. The sheet of paper is folded in a particular manner to form a deep, large, inverted conical-shaped catch basin with a wide top opening. The catch basin maintains its shape during use and when the debris collector is detached from the wall.

The sheet of paper is rectangular or square-shaped and has four perpendicularly aligned edges, four corners, a front surface, a back surface, and midline longitudinal and transverse axes. An upper adhesive is attached or applied to the back surface of the sheet along the top edge. The upper adhesive may extend the full length of the top edge. In one embodiment, the ends of the top edge are clear of adhesive which allows the two top corners of the sheet to bend outward thereby reducing the outward force exerted on the upper adhesive. As discussed further below, a lower adhesive is attached or applied to the front surface of the sheet along the lower edge.

During use, the sheet is oriented so that the top and bottom edges are horizontally aligned, and the two side edges are vertically aligned. The two lower corners of the sheet are then pulled upward and inward over the front surface of the sheet and aligned over the sheet's midline axis. When the two lower corners are folded upward and inward over the midline axis, the bottom edge is folded into two half-edge segments. The two half-edge segments also become vertically aligned over the sheet's midline axis. The lower adhesive is then used to hold the entire lengths of the two half-edge segments together. In one embodiment, the lower adhesive is applied to the outside surface of one of the half-edge segments. A sealed front seam is formed and creates a large catch basin. After the half-edge segments are attached and the catch basin is formed, the upper adhesive on the back surface of the top edge of the sheet is then pressed into the wall under the area where dust particles fall.

The size of the sheet of paper is flexible and not restricted to a specific dimension. However, for most applications, common sizes (in inches) include 8.5×8.5; 8.5×11; 11×11; 11×14; and 14×17. The paper must be stiff enough to allow the sheet's side edges to bend inward and the bottom edge to bend upward so that when the two half-edge sections are connected, the catch basin extends outward. Standard paper with a weight of 20 to 30 pounds is suitable for this purpose.

As described earlier, the lower adhesive is used to join the two half-edge sections of the sheet. Lower adhesive may be attached to the outside surface along one or both half-edge segments. When attached, a sealed, vertical front seam is formed. To increase the contact area, as the two half-edge sections are vertically aligned over the midline axis, they may be folded inward so that they face each other. The lower adhesive can be a peel-and-stick type, covered by a removable film attached to one or both half-edge sections. If additional support is required, a second strip of adhesive tape, such as painter's tape, can be applied over the joined sections to reinforce the front seam.

During manufacturing, the upper adhesive is pre-applied by the manufacturer along the inside surface of the top edge of the paper. Depending on the intended application, the sheet of paper may be produced in either a landscape orientation, where the top edge is the longer side, or a portrait orientation, where the top edge is the shorter side. This flexibility in orientation allows for variations in the size and shape of the catch basin to suit different uses.

### BRIEF DESCRIPTION OF DRAWINGS

FIG. 1 is an illustration showing a sheet of paper with a folded lip used in the prior art that attaches to a wall and is used to collect dust particles and debris created by a drill forming a hole in the wall.

FIG. 2 is an illustration showing a sheet of paper with a folded lip attached to a wall showing how debris falling from a saw misses the lip and falls to the ground.

FIG. 3 is a front perspective of a disposable debris collector described herein attached to a vertical surface.

FIG. 4 is a front elevational view perspective of the disposable debris collector shown in FIG. 3 with peel and stick adhesive disposed between the two half-edge sections to form a front seam.

FIG. 5 is a partial front elevational view of the debris collector showing adhesive tape placed over the outside surface of the sheet adjacent to the top edge to attach the top edge of the debris collector to a vertical surface.

FIG. 6 is a top plan view showing the two half-edge segments folded inward forming flaps that are then aligned over sheet's midline axis, the two flaps face each other with a lower adhesive applied to one flap on one half-edge segment.

FIG. 7 is similar to FIG. 6 showing a lower adhesive applied to both flaps on the two half-edge segments.

FIG. 8 is a partial front elevational view of the debris collector, showing a strip of adhesive tape applied over the two half-edge segments.

FIG. 9 is a partial top plan view showing the flaps being pressed together as shown in FIGS. 6 and 7 and showing an optional outer tape strip being applied over the front seam.

FIG. 10 is a side elevational view of the debris collector attached to a vertical surface and showing the catch basin extending away from the vertical wall and collecting falling dust particles.

FIG. 11 is a front plan view of the debris collector attached to a wall in which the sheet of paper is oriented so that the sheet's long edge is horizontally aligned on the wall.

FIG. 12 is a side elevational view of the debris collector shown in FIG. 11.

FIG. 13 is a front plan view of the debris collector attached to a wall in which a short edge of a sheet of paper is horizontally aligned on the wall.

FIG. 14 is a side elevational view of the debris collector shown in FIG. 13.

FIG. 15 is a top plan view of the debris collector attached to the inside corner formed by two walls.

FIG. 16 is a side elevational view of the debris collector showing the top edge being bent horizontally and attached to the top surface of a table or desk, and showing the catch basin hanging vertically over the side of the table or desk.

FIG. 17 is a front plan view of the sheet of paper prior to being folded into the debris collector shown in FIGS. 3 and 4.

FIG. 18 is a rear plan view of the sheet of paper shown in FIG. 17.

FIGS. 19 and 20 illustrate how a sheet of paper, shown in FIGS. 17 and 18, is manually folded to make the debris collector with the catch basin.

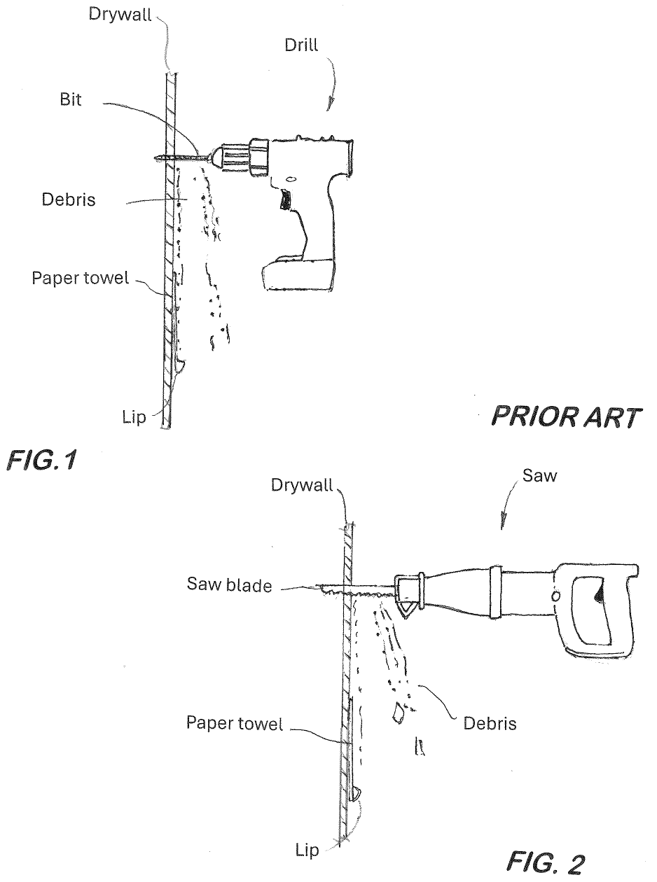

### DETAILED DESCRIPTION OF THE INVENTION

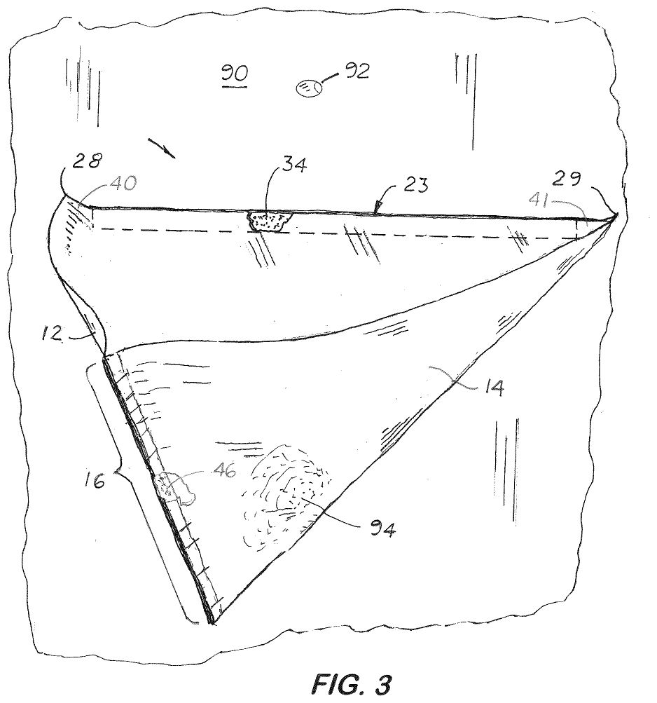

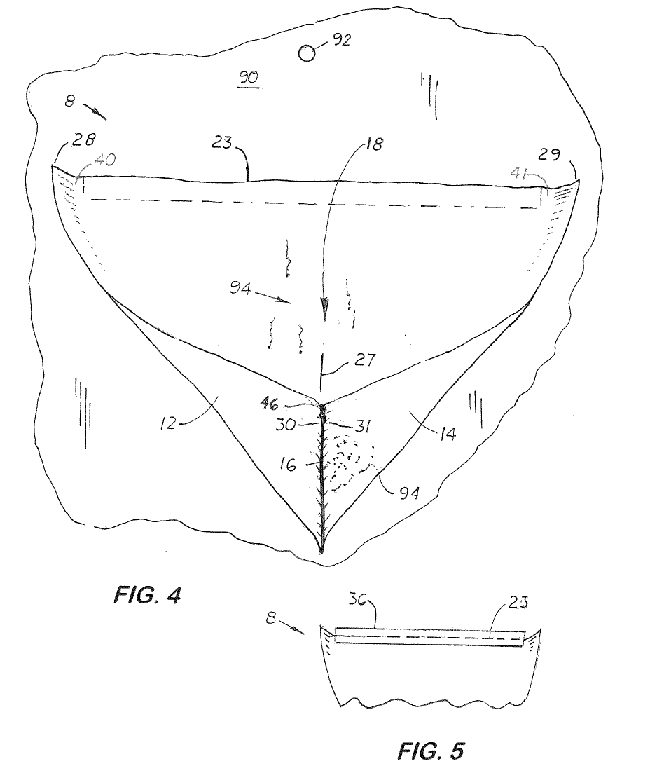

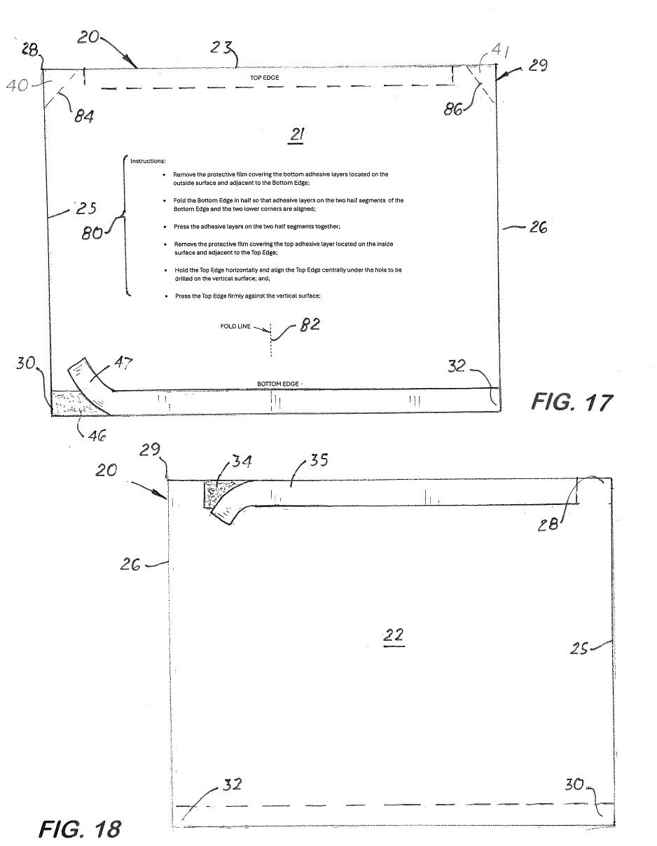

A temporary debris collector 8, shown in FIGS. 3 and 4, is used to collect falling dust particles or small debris (both designed by reference 90 when drilling or cutting a hole 92 or opening on a wall or vertical surface 90. The debris collector 8 is formed from a sheet of paper 20 (hereinafter sheet 20) shown in FIGS. 17-20, includes a front surface 21, a back surface 22, a top edge 23, a bottom edge 24, two side edges 25, 26, a midline axis 27 of the bottom edge 24, and four corners 28-31. An upper adhesive 34 is attached or applied to the back surface 22 of the sheet 20 along the top edge 23. A lower adhesive 46 is attached or applied to the front surface 21 along the bottom edge 24.

When formed, the debris collector 8 has a sloped back wall 10 with two integrally formed curved side walls 12, 14. As discussed below, the two lower corners 30, 31 are pulled inward towards the sheet's midline axis 27. In the embodiment shown in FIGS. 3, 4 and 11, the sheet 20 is oriented so that the top and bottom edges 23, 24, respectively, are horizontally aligned, and the two side edges 25, 26 are vertically aligned. It should be understood, however, that the sheet 20 may be oriented with the edges 25 and 26 horizontally aligned as shown in FIGS. 13 and 14.

To make the debris collector 8, the two lower corners 30, 31 of sheet 20 are pulled upward and inward over the front surface 21 and aligned over the bottom edge's midline axis 27. When the two lower corners 30, 31 are folded upward and inward over the midline axis 27, the bottom edge 24 is folded into two half-edge segments, 37, 38. The edges of the two half-edge segments 37, 38 are vertically aligned over the sheet's midline axis 27. The lower adhesive 46 is then used to hold the entire lengths of the two half-edge segments 37, 38 together and forming a front seam 16. Due in part to the stiffness of the sheet 20, large catch basin 18 is formed behind the front seam 16. After the catch basin 18 is formed, the upper adhesive 34 on the back surface 22 of the top edge 23 of the sheet 20 is then pressed into the wall 90 under the area where dust will be created.

As shown in FIG. 3, an upper adhesive 34 is applied to the inside surface of sheet 20 adjacent to the top edge 23. The upper adhesive 34 is a rubber or acrylic-based, low-tack, pressure-sensitive adhesive, commonly called ‘peel-and-stick adhesive’, is applied to the back surface 22. The upper adhesive 34 may be covered by removable film 35. The upper adhesive 34 may be applied to attach to the entire top edge 23 or, as shown in FIG. 3, may be applied to the central area and leaving the two areas 40, 41 adjacent to the two top corners 28 and 29 clear of upper adhesive 34. By leaving the areas 40, 41 near the two top corners 28, 29 clear of upper adhesive 34, the corners 28, 29 can gradually curve and bend outward, which minimizes the outward pulling force exerted on the upper adhesive 34. As shown in FIG. 5, a strip of painter's tape 36 that overlaps the top edge 23 and the vertical surface 90 may be used if additional support is needed.

A lower adhesive 46 is used to attach or hold the two half segments 37, 38 together thereby forming the front seam 16. Like the upper adhesive 34, the lower adhesive 46 is a rubber or acrylic-based, low-tack, pressure-sensitive adhesive, commonly called ‘peel-and-stick adhesive’ is applied to the front surface 21 of the debris collector 8. In one embodiment, the adhesive 46 covers the front surface 21 along the entire bottom edge 24. The width of the lower adhesive 46 is between ⅛ to ½ inches. The adhesive 46 is covered by removable film 47.

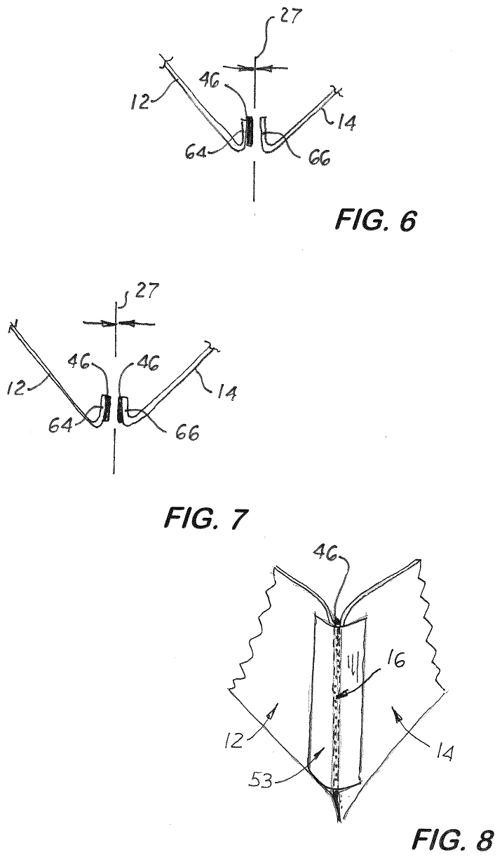

FIG. 6 is a partial top plan view of the debris collector 8 showing the two half-edge segments folded inward and forming flaps 64, 66. During the folding process, the two half-edge segments 37, 38 are pulled inward so the two flaps 64, 66, respectively, face each other over the lower edge's midline axis 27. As shown, the lower adhesive 46 may be applied to one flap 64 on one half-edge segment 37. FIG. 7 shows the lower adhesive 46 applied to both flaps 64 and 66 to provide greater adhesion.

FIG. 8 is a partial front elevational view of the debris collector 8, showing the edges of the two half-edge segments 37, 38 being abutted and a strip of adhesive tape 53 applied over the two half-edge segments 37, 38.

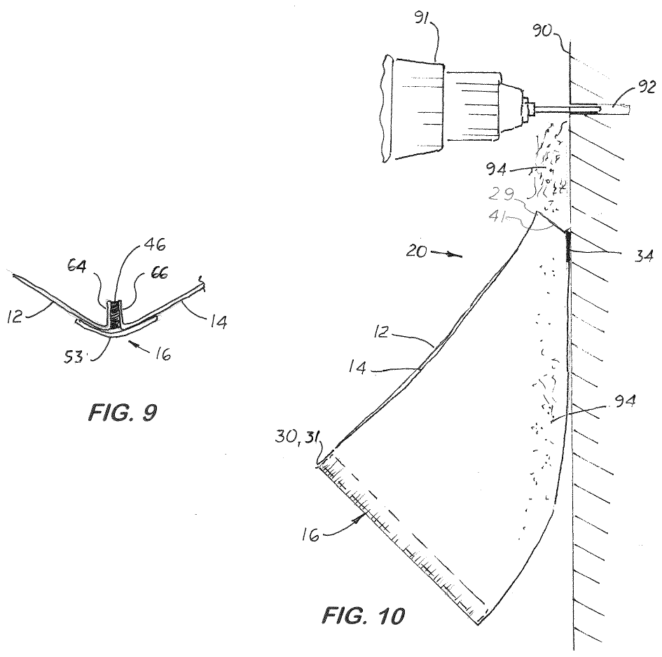

FIG. 9 is a partial top plan view showing the flaps 64, 66 being pressed and held together with the lower adhesive 46 and showing an optional outer strip of adhesive tape 53 being applied over the front seam 16.

FIG. 10 is a side elevational view of the disposable debris collector 8 attached to vertical surface 90 and used to collect debris 94 from a hole 92 formed in the vertical surface 90 by a drill 91. Because the two corners 43, 44 and the bottom edge's two half-edge segments 37, 38 are pulled upward and attached, the catch basin 18 extends several inches away from the vertical surface 90.

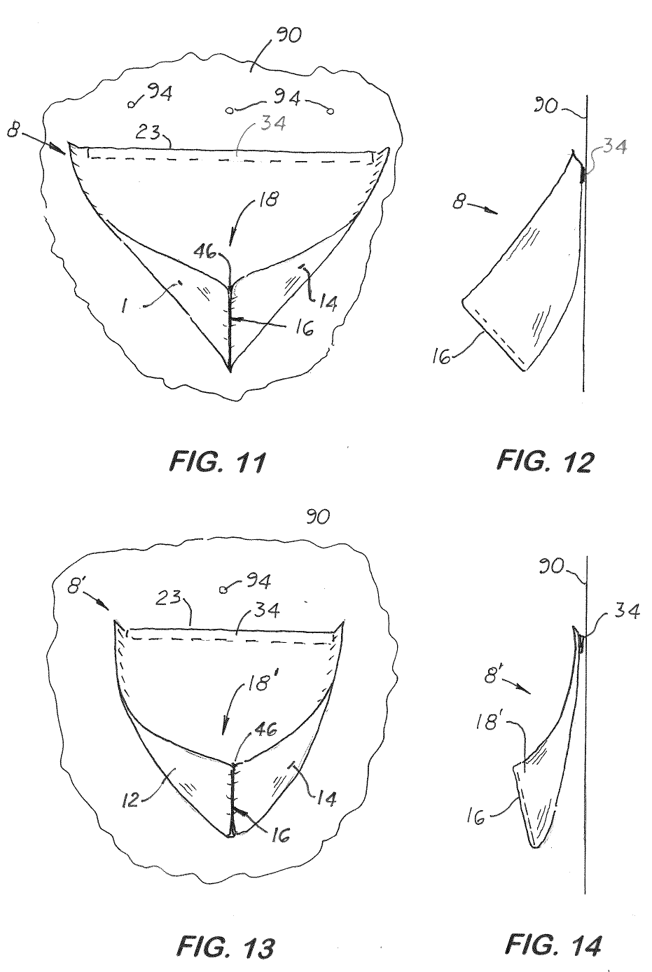

FIGS. 11-14 illustrate how the shape of the debris collector 8 can vary depending on how the sheet is paper 20 is oriented. The sheet 20 can be oriented in either portrait or landscape orientation, and the top edge 23 may be the sheet's long edge as shown in FIGS. 11 and 12 or it may be the sheet's short edge as shown in FIGS. 13 and 14. When the sheet 20 is rectangular, using different edges determines the overall length and width. When oriented in landscape orientation, as shown in FIGS. 11 and 12, the catch basin 18 formed on the debris collector 8 wider and extended further from wall 90. The landscape orientation is desired by cutting a plurality of holes 94 in the wall 90. FIGS. 13 and 14 show the debris collector 8′ with the sheet 20 oriented in a portrait orientation with the top edge 23 being the short edge. When oriented in portrait orientation, the catch basin 18′ is narrow and wider and extends less from wall 90. The portrait orientation is desired by cutting one or two small holes 94 in the wall 90.

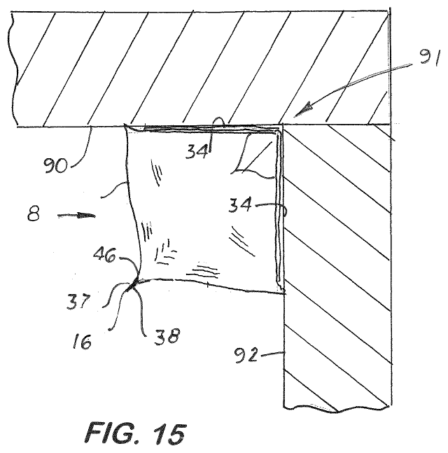

It should also be noted that because the debris collector 8 is made from a sheet of paper 20, the debris collector 8 may bend along the bottom edge's midline axis 27, thereby enabling the debris collector 8 to be used on an inside corner between two walls 90 and 92, as shown in FIG. 15.

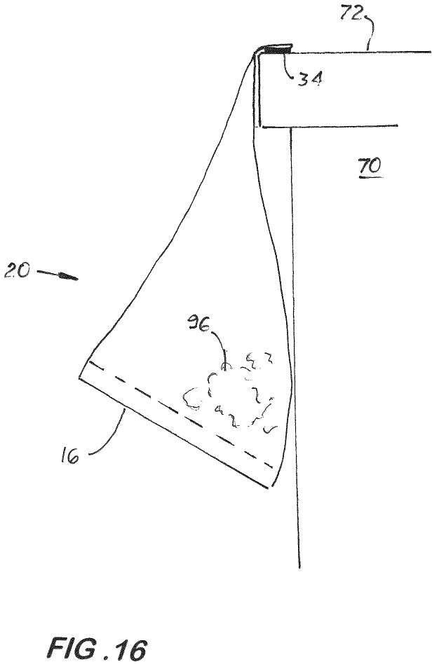

Because the back surface 22 of the sheet 20 near the two top corners 28, 29 is clear of the upper adhesive 34, the top edge 23 can be bent horizontally and attached to a flat horizontal surface. This allows the debris collector 8 to be used as a trash collector by attaching the upper adhesive 34 to the top surface 72 of a table 70 and then bending the lower area of the sheet 20 downward to position the catch basin 18 over the side of the table 70. (see FIG. 16).

FIGS. 17 and 18 show front and rear views of a sheet of paper 20, respectively, used to make the debris collector 8. As shown in FIG. 17, printed folding instructions 80 and a fold line 82 are printed on the front surface 21. Fold line 82 is aligned with the lower edge's midline axis 27. Also, optional diagonal cutlines 84 and 86 may be printed on each corner. During assembly, the user may cut along the cutlines 84, 86 to remove the corners which reduces the outward pulling force exerted on the upper adhesive 34. When large catch basins are desired, removing the corners also allows the catch basin 18 to extend further from the wall 90. Attached to the inside surface of the sheet 20 along the top edge 23 is an upper adhesive 34 covered with a removable film 35. As mentioned above, in the embodiment shown, no upper adhesive 34 is applied to the top edge 23 near the corners which allows the side edges to bend and curve outward to reduce the pulling force exerted on the upper adhesive. Attached to the outside surface of the sheet 20 along the bottom 24 is a lower adhesive 46 covered with a removable film 47.

As mentioned above, the size of the sheet of paper 20 is flexible and not restricted to a specific dimension. However, for most applications, common sizes (in inches) include 8.5×8.5, 8.5×11, 11×11, 11×14, and 14×17. The sheet of paper 20 must be stiff enough to allow the side edges 25, 26 to bend inward and the bottom edge 24 to bend upward, creating two half-edge segments 37, 38 so that the catch basin 18 extends outward from the wall 90. Standard paper with a weight of 20 to 30 pounds is suitable for this purpose.

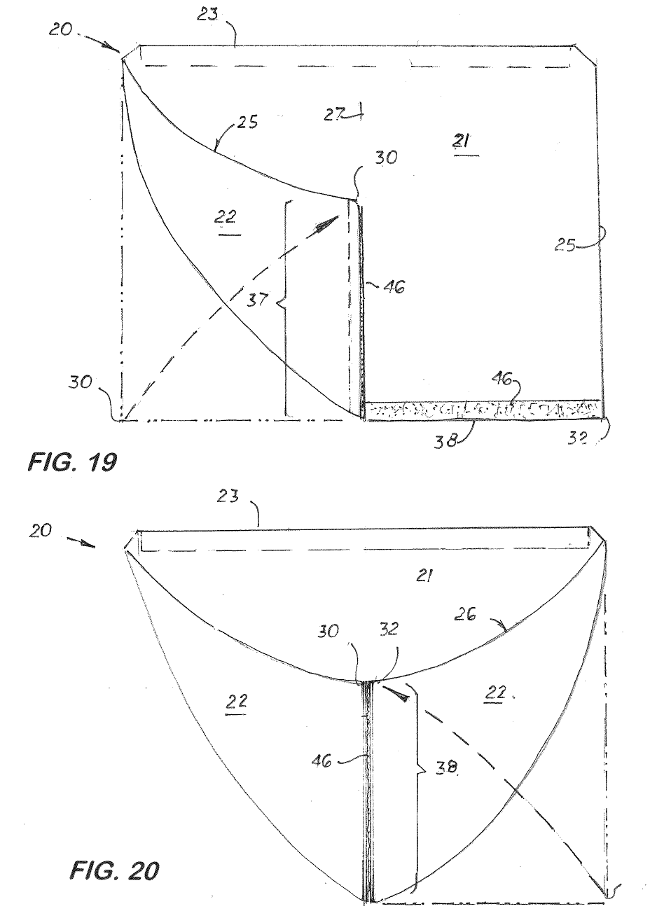

FIGS. 19 and 20 illustrate how a sheet of paper 20, shown in FIGS. 17 and 18, is manually folded to make the debris collector 8. In the Figs, the top corners of the sheet 20 have been removed. The sheet 20 is placed on a flat surface with the front surface 21 facing outward. The two lower corners 30, 31 of the sheet 20 are pulled upward and inward over the front surface 21 and aligned over the bottom edge's midline axis 27. When the two lower corners 30, 31 are folded upward and inward over the midline axis 27, the bottom edge 24 is folded into two half-edge segments, 37, 38. The edges of the two half-edge segments 37, 38 may be vertically aligned over the midline axis 27. Alternatively, the edges of the two half-edge segments 37, 38 may be folded inward to face each other. The film 47, if present, is removed from the lower adhesive 46. The edges or flaps are pressed together enabling the lower adhesive 46 to hold the two half-edge segments 37, 38 together and form a front seam 16. Because the sheet 20 is made of at least 20 lb paper, a wide, forward extending catch basin 18 is formed. The film 35 on the upper adhesive 34 on the back surface 22 is removed and the top edge 23 of the sheet 20 is then pressed into the wall 90 under the area where dust will be created.

In compliance with the statute, the invention described has been described in language more or less specific as to structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted under the doctrine of equivalents.

I claim:

1. A wall-mounted, inverted conical-shaped debris collector comprising;
a. a sheet of paper with a front surface, a back surface, two top corners, a top edge, a right edge, a left lower corner, a right lower corner, and a bottom edge extending between said left lower corner and said right lower corner, said bottom edge includes a midline axis, said bottom edge being pulled upward over said front surface and folded around said midline axis and forming two vertically aligned half-edge segments;
b. an upper adhesive applied to said back surface of said sheet of paper adjacent to said top edge; and
c. a lower adhesive applied to one or both said two half-edge segments adjacent to said bottom edge, said lower adhesive configured to hold said two half-edge segments together, thereby forming a catch basin.

2. The debris collector, as recited in claim 1, wherein said upper adhesive is covered by a removable film.

3. The debris collector, as recited in claim 1, further includes a removable film that covers said lower adhesive.

4. The debris collector, as recited in claim 2, further includes a removable film that covers said lower adhesive.

5. The debris collector, as recited in claim 1, further includes a fold line printed on said front surface aligned with said midline axis of said bottom edge.

6. The debris collector, as recited in claim 1, further includes areas on said back surface adjacent to each said top corner that is clear of said upper adhesive.

7. The debris collector, as recited in claim 6, further includes a removable film that covers said upper adhesive.

8. The debris collector, as recited in claim 1, wherein said sheet of paper weighs 20 to 30 lbs.

9. The debris collector, as recited 8, wherein said sheet of paper is one of the following sizes: 8.5×8.5; 8.5×11; 11×11; 11×14; or 14×17.

10. Method for making a disposable debris collector from a single sheet of paper, comprising the following steps:
a. selecting a square or rectangular sheet of paper a front surface, a back surface, two upper corners, a top edge, a right edge, and a left edge, two lower corners, and a bottom edge with a midline axis that divides said bottom edges into two equal lengths, half-edge segments, said sheet of paper also includes an upper adhesive located on said back surface aligned with said top edge and a lower adhesive located on said front surface aligned with at least one of said half-edge segments;
b. folding said bottom edge upward and over said front surface until said two half-edge segments are aligned over said midline axis and adjacent to each other and creating a forward seam;
c. forcing said lower adhesive on said half-edge segment against the adjacent said half-edge segment thereby forming a catch basin; and,
d. forcing said upper adhesive against to a wall to collect falling dust particles produced when drilling or cutting into said wall.

11. The method, as recited in claim 10, further includes between steps b and c, the step of forming a flap on each said half-edge segment, each said flap being folding inward to face said flap on said adjacent half-edge segment when said half-edge segments are aligned with said midline axis.

12. The method, as recited in claim 10, further including the step of attaching a second strip of adhesive tape over said front seam.

13. The method, as recited in claim 10, further including the step of attaching a second strip of tape over said top edge to hold said debris collector on said wall.
